(19) United States
(12) Patent Application Publication
(10) Pub. No.: US 2004/0166214 A1
(43) Pub. Date: Aug. 26, 2004

(54) Film coatings containing pearlescent pigments and edible articles coated therewith

(76) Inventors: Pamela K. Gesford, Harleysville, PA (US); Diane C. Kunkle, Coopersburg, PA (US)

Correspondence Address: MUSERLIAN AND LUCAS AND MERCANTI, LLP, 475 PARK AVENUE SOUTH, NEW YORK, NY, 10016, US

(21) Appl. No.: 10/778,563

(22) Filed: Feb. 13, 2004

Related U.S. Application Data
(60) Provisional application No. 60/448,988, filed on Feb. 20, 2003.

(51) Int. Cl. A23B 4/00

(52) U.S. Cl. 426/302

(57) ABSTRACT

Foods and confections having a pearlescent outer coating, as well as coated foods having enhanced visual appeal are disclosed. In certain preferred aspects, the coatings are prepared using powder mixtures which include from about 5 to about 50% by weight of a pearlescent pigment, from about 15 to about 90% by weight tapioca dextrin, from about 2 to about 10% by weight of a surfactant, up to about 5% by weight of a cellulosic polymer and optionally up to 20% by weight dextrose. Methods of preparing the powder mixture and aqueous suspensions containing the same are also disclosed.

### CROSS-REFERENCE TO RELATED APPLICATIONS

This application claims the benefit of priority from U.S. Provisional Patent Application No. 60/448,988, filed Feb. 20, 2003, the contents of which are incorporated herein by reference.

### BACKGROUND OF THE INVENTION

1. Field of the Invention

The present invention relates to film coatings having improved pearlescent qualifies. The invention also relates to edible substrates such as candies or foods which have been film coated with the improved pearlescent film coatings and methods of preparing the same.

2. Description of the Prior Art

In recent years, efforts have been made to increase the visual appeal of various edible articles. Competition among food and confectionery manufacturers is intense. Each tries to differentiate their goods from those of other manufacturers as a way of building brand loyalty and/or increasing market share among consumers. Moreover, manufacturers are often able to obtain a premium price for goods which have a unique or highly elegant appearance. Briefly stated, manufacturers are constantly striving to come up with innovations which have increased subjective appeal to consumers.

The candy and confectionery arts have proposed increasing visual appeal using various techniques. For example, various shellacs and film coatings have been proposed which provide substrates with a bright or highly polished finish coat. More recently, the food industry has attempted to introduce a pearlescent or nacreous quality to the outer surface of foods and confections as a means of increasing visual appeal to consumers. One such product line which is useful in edible products is sold under the trade name Candurin® by Merck KGaA. The pearlescent pigments are titanium oxide and/or iron oxide pigments supported on a base of lamellar substrate comprising mica or flakes of Al₂O₃, SiO₂ or TiO₂.

PCT patent application having publication number WO 00/03609 discloses coated articles prepared using Candurin pearlescent pigments. The published document discloses that coating materials which can include the pearlescent pigments are sugars, shellacs (both aqueous and ethanolic), polymethacrylates and “cellulose types” including specifically HPMC and Sepifilm® LP (HPMC, MCC and stearic acid). Articles coated with the pearlescent coatings include sugar products (e.g. caramel), cake decorations, chewing gum, chocolate, ice cream, cereals, snack products, nonpareils, gelatin products, candy, licorice, icing, cream compositions, tablets and capsules. There is no disclosure, however, regarding how the surface of the article to be coated affects the quality of the pearlescent coating or what treatments could be applied to the surface of the article in order to obtain a high gloss pearlescent coating.

Product literature promoting the use of Candurin pearlescent pigments for sugar coated panned (pan coated) products instructs customers that the products to be colored with the product should have a dust free smooth surface and that pre-treatment with other glazing agents is not necessary. In spite of these teachings and those provided in WO 00/03609, further improvements have been sought. For example, it has been found that it would be desirable to provide a higher gloss finish on articles containing pearlescent coatings. In addition, contrary to what was taught in the above mentioned product literature, it has been found that the presence of certain subcoats on food substrates does indeed provide unexpected improvements in the appearance of pearlescent coated products, especially when pan coating is employed. The present invention addresses these and other needs.

### SUMMARY OF THE INVENTION

In one aspect of the invention there is provided a dry powder mixture useful in preparing film coatings used in the food and confection arts. The powder mixture or blend includes from about 5 to about 50% by weight of a pearlescent pigment, from about 15 to about 90% by weight tapioca dextrin, from about 2 to about 10% by weight of a surfactant, up to about 5% by weight of a cellulosic polymer; and from 0 to about 20% by weight dextrose. In preferred aspects of this embodiment, the cellulosic polymer is sodium carboxymethyl-cellulose and the surfactant is soya lecithin. The preferred pearlescent pigments are those which include titanium dioxide platelets or micaceous based pearlescent pigments.

In another aspect of the invention there is provided a suspension for coating edible substrates. The suspension includes from about 5 to about 30% by weight of the powder mixture described above and from about from about 70 to about 95% by weight water. Still further aspects include methods of coating edible substrates with the suspension and the coated edible articles.

A further aspect of the invention includes an alternative method of coating edible substrates in which a cellulosic polymer-containing subcoat is applied to the edible substrate before the pearlescent coating is applied. The amount of subcoat applied is preferably an amount which renders the surface of the edible article substantially smooth but does not materially effect the organoleptic qualities of the article. The pearlescent coated edible substrates prepared by this alternative method are also part of the invention.

As a result of the present invention, several advantages and improvements over the prior art are realized. For example, the artisan is now able to provide edible food articles with higher degrees of pearlescence and shine.

### DETAILED DESCRIPTION OF THE INVENTION

A first aspect of the invention includes dry powder mixtures which are useful in preparing film coatings which preferably have pearlescent qualities when applied to foods, confections and the like. The film coatings made with the powders are typically applied as aqueous suspensions using pan coating or spraying techniques well known to those of ordinary skill. The inventive powder mixtures include:

a) from about 5 to about 50% by weight of a pearlescent pigment;

b) from about 15 to about 90% by weight tapioca dextrin;

c) from about 2 to about 10% by weight of a surfactant;

d) less than about 5% by weight of a cellulosic polymer; and

e) from about 0 to about 20% by weight dextrose.

The powder mixtures are prepared using standard dry blending or mixing techniques known to those of ordinary skill. For example, the ingredients are individually weighed, added to a suitable apparatus and blended for a sufficient time until a substantially uniform mixture of the ingredients is obtained. The time required to achieve such substantial uniformity will, of course, depend upon the batch size and apparatus used. It is contemplated that mixing times of from a few minutes to about 10 minutes will be sufficient and that no undue experimentation is required in order to achieve the substantially uniform mixture of the individual ingredients. If any of the powder formulation ingredients are liquids, they are added only after all of the dry ingredients have been sufficiently blended, e.g. for about 5 minutes, and the combination of wet and dry ingredients is blended for a sufficient time, typically about an additional 5 minutes, once all of the liquid is introduced.

As mentioned above, batch sizes will vary upon need. A non-limiting list of suitable blending devices include diffusion blenders such as a cross flow, V-blender, or hub blender, available from Patterson-Kelly, or Convection blenders, such as Ruberg or CVM blenders, available from Azo and Readco, respectively, may be used. Blending of the aforementioned formulation may also be achieved by processing ingredients into a granular form to produce a non-dusting granular coating composition by methods including, but not limited to, wet massing, fluid bed granulation, spray granulation and dry compaction, roller compaction or slugging. Other manners of blending will be apparent to those of ordinary skill.

In preferred aspects of the invention, the powder mixtures include (by weight) from about 6 to about 20% pearlescent pigment, from about 1 to about 4.9% cellulosic polymer, from about 25 to about 60% tapioca dextrin, from about 5 to about 9% surfactant and from about 5 to about 15% dextrose. In some particularly preferred aspects of the invention, the powder mixtures include (by weight) from about 7 to about 13% pearlescent pigment, from about 2 to about 4% cellulosic polymer, from about 45 to about 60% tapioca dextrin, from about 7.0 to about 8.5% surfactant and from about 7 to about 10% dextrose.

In an alternative aspect of the invention, the amount of pearlescent pigment employed in the powder mixtures of the invention is an amount which is sufficient or effective to impart an improved pearlescent outer coating to the surface of an edible article while the amounts of the remaining ingredients are the same as that set forth above, so long as the total amount of ingredients, e.g. cellulosic polymer, tapioca dextrin, surfactant and any optional ingredients, discussed in detail below, in sum is 100%.

One of the keys to present invention is the ability to impart improved pearlescence to the surface of edible articles. In this regard, the choice of pearlescent pigment included in the powder mixtures needs to take into account that the pigment portion should be one which meets or is capable of meeting all government approval requirements for human consumption. In one preferred embodiment of the invention, the pearlescent pigments included are based on titanium dioxide platelets, also known as platy TiO₂, such as those available from Engelhard and/or those described in U.S. Pat. Nos. 5,611,851 and 6,627,212 the disclosures of which are incorporated herein by reference. Such products can be referred to as platelets of titanium dioxide. A non-limiting list of suitable pearlescent platy TiO₂ pigments include green, blue, violet, red, gold, orange, and pearl. See also, for example, Greenstein, L. M. “Nacreous Pigments” Encyclopedia of Polymer Science and Technology, Vol. 10, pp 193-215. Such pigments are available in a wide variety of colors such as reds, golds, violets, greens, etc.

In an alternative aspect of this embodiment, the pearlescent pigment is a micaceous pearlescent pigment such as those available under the tradename Candurin from Merck as mentioned above. See also PCT publication number WO 00/03609, the disclosure of which is incorporated herein by reference. A non-limiting list of suitable pearlescent pigment products include Candurin silver fine, silver sheen, silver luster and sparkle silvers, etc. various “sugar” products like banana sugar or others having a white color and gold, red or blue highlights. Still others include those having various colors, e.g. reds, bronzes, coppers having glitter or luster finishes. Other suitable micaceous pigments are those containing mica coated with titanium dioxide, ferrous oxide, etc. and combinations thereof. The only limitation on the pearlescent pigments included in the powders and other formulations described herein is that they must be capable of being substantially homogeneously combined with the other ingredients and they must be capable of providing a high pearlescent finished coating on the coated, edible article without substantially negatively effecting the organoleptic qualities of the finished product.

The cellulosic polymer included in the powder mixtures can be selected from among the many food grade and/or pharmaceutically acceptable products known to those of ordinary skill. In preferred aspects, however, the cellulosic polymer is a hydroxypropylmethylcellulose (HPMC), a sodium carboxymethylcellulose (NaCMC), hydroxypropylcellulose (HPC), carboxymethylcellulose and combinations thereof. In more preferred aspects, the cellulosic polymer is NaCMC.

The surfactant included in the powder mixtures of the invention can be selected from among lecithin, stearic acid, polysorbates, monoglycerides, diglycerides and mixtures thereof. More preferably, the surfactant is soya lecithin.

A buffer such as sodium citrate may also be included in the powder mixtures. The amount of buffer is typically from to about 0.01 to about 3% by weight. Furthermore, the powder mixtures may also include supplemental or auxiliary ingredients typically found in food coatings. A non-limiting list of such adjuvants include colorants, flavorants, glidants, etc. and mixtures thereof. The colorants are present in amounts ranging from about 0.0001 to about 30% by weight and can be selected from among the food-acceptable ingredients such as FD&C lakes, titanium dioxide, dyes and natural colorants. Secondary film formers such as sodium alginate, propylene glycol alginate, polyvinylpyrrolidone, polydextrose and maltodextrin can also be included. The powders may further include a flow aid such as talc, fumed silica, edible hydrogenated vegetable oils, hydrogenated vegetable oil and waxes, etc.

In another embodiment of the invention there are provided (aqueous) coating suspensions containing the powder mixtures described above. Such suspensions can include from about 5 to about 30% by weight of the powder mixtures and from about 70 to about 95% by weight water. More preferably, the suspensions contain from about 80 to about 95% by weight water. Any optional ingredients not part of the powder mixture can be added to the suspension either during the formation of the suspension described below or as a supplemental step after the initial product has been formed. Regardless of the ingredients included in the suspension, the final product applied to the food articles will have a solids content of at least about 2% solids, preferably from about 5 to about 20% and more preferably from about 8 to about 15%.

For purposes of illustration and not limitation, an aqueous suspension can be formed by dispersing a blended powder mixture described hereinabove into water at ambient temperature. The water is weighed into a suitable vessel, i.e. one with a diameter approximately equal to the depth of the final suspension. A low shear mixer, preferably one having a mixing blade with a diameter about one third the diameter of the mixing vessel, is lowered into the water and turned on to create a vortex from the edge of the vessel down to about just above the mixing blade to prevent entrapment of air. The dry film coating composition is added to the vortex at a rate where there is no excessive build up of dry powder. The speed and depth of the mixing blade is adjusted to avoid air being drawn into the suspension so as to avoid foaming. The suspension is stirred for a sufficient amount time to assure that a homogenous mixture is formed. The suspension is then ready for spraying onto the edible substrates. Those of ordinary skill will also realize that there are many ways of preparing a substantially homogenous mixture of the solids in water and that the scope of the invention is in no way dependent on the apparatus used.

In a still further embodiment of the invention there is provided a method of coating edible articles or substrates using the suspensions described herein. As will be described in the Examples below, the methods include applying the suspensions to the food articles as part of a pan coating or spray coating process commonly used to coat such articles. The amount of coating applied will depend upon several factors, including the food article to be coated, the amount and color of the pearlescent pigment included in the suspension, the apparatus employed to apply the coating, etc. Mixing or agitation of the pigmented coating suspensions is usually done during spray applications to prevent settling of the suspension and maintain a uniform appearance on the food articles. The suspensions may also be applied in aerosol form. For example, the suspensions may be packaged in an aerosol container designed for home or commercial use by using standard techniques known to those of ordinary skill and applied as a decorative spray on baked goods including cakes, cookies and brownies. In most aspects of the invention, the amount of pearlescent coating applied will be from about a 0.1 to about a 5% theoretical weight gain, with amount of from about 0.5 to about a 3% being preferred.

In order obtain a more visually appealing pearlescent coating on some food articles, it is preferable to apply a subcoat on the food article before the pearlescent coating is applied. The purpose of the subcoat is to provide the food article with an exterior surface which is substantially smooth before the novel pearlescent coatings are applied. While applicants are not bound by theory, it is believed that the visual qualities of the dried pearlescent coat are unexpectedly improved when they are applied to surfaces which are substantially smooth. For purposes of the present invention, a surface which is “substantially smooth” shall be understood to be a surface which is substantially free of rough or coarse areas.

It shall further be understood that the surfaces to which the inventive suspensions can be applied include baked goods or other products which are porous and absorbent in nature such as cookies, biscuits, etc. In these aspects, the subcoat plays a particularly important role in allowing the later-applied, pearlescent pigmented coating to achieve its high visual appeal on the baked goods. It will understood, of course that the subcoat can applied either before or after baking of the goods, depending on their nature, but the pearlescent pigment coat is preferably applied after baking is completed.

The artisan may choose from a wide variety of food-acceptable coatings for use as subcoats in the present invention. Preferably, however, the coating solution/suspension used as the subcoat will contain a cellulosic polymer such as NaCMC, especially when the pearlescent coating applied thereafter is an aqueous-based system. A non-limiting list of suitable coatings include those sold under the tradenames OPADRY®, OPADRY TYPE F® and OPAGLOS® by Colorcon of West Point, Pa. The subcoat may also be free of pigment or include a sufficient amount of a pigment which imparts added luster or visual effect to the pearlescent coating applied to the food article. In most aspects of the invention, the subcoat will be applied to a theoretical weight gain of from about 0.1 to about 5%, with amounts of from about 0.25 to about 3% being preferred. The subcoat may also be a traditional food coating or glaze. For example, the subcoat may be tempered chocolate, which could be applied to baked goods such as pretzels to produce a very smooth surface prior to coating with the pearlescent coating compositions.

The types of edible articles which can be coated with the inventive coating systems is vast. It includes, without limitation, confectionery items, foods, snacks etc. such as tempered chocolates, licorice, pretzels, cookies of all types and other baked goods such as ice cream cones, crackers, enrobed cookies, jelly beans, soft panned items, gumballs, Jordan almonds, various panned confectionery items, chocolate panned nuts, white confectionery coating/yogurt coated products like raisins, caramel pieces, malt balls, smooth hard candies including deposited types, gummy bears or other shapes, molded and enrobed chocolates

### EXAMPLES

The following examples serve to provide further appreciation of the invention but are not meant in any way to restrict the effective scope of the invention. For purposes of the present invention, “lentils” are understood as being candy coated (not film) hard panned chocolate pieces having the appearance of lentils, including an unpolished outer surface which contains deposits of fine crystalline sugar and is therefore not completely smooth.

### Example 1

In this example, a substantially clear subcoat was applied using a side vented pan coating process to brown lentils until about a 1% weight gain was observed before a coating corresponding to the present invention was applied. As a result, the exterior of the lentils was transformed from a rough surface into one which is substantially smooth. The subcoat formula set forth below was applied as a 10% solution solids by pan coating.

### Subcoat Formula

| Item | Common Name | Wt % |
|---|---|---|
| 1 | HPMC 6 cP | 45.500 |
| 2 | maltodextrin 10 DE | 27.000 |
| 3 | HPMC 3 cP | 14.000 |
| 4 | PEG 400 NF | 10.000 |
| 5 | HPMC 50 cP | 3.500 |
| | | 100.000 |

After the subcoated lentils were allowed to dry, a pearlescent coating containing a platy TiO₂ as a 15% by weight solids is applied to a 2% theoretical total weight gain using a side vented pan process. The formula for the coating is set forth below:

### Pearlescent Coating Formula

| Item | Component | Wt % |
|---|---|---|
| 1 | tapioca dextrin | 58.300 |
| 2 | gold platy TiO₂ | 20.000 |
| 3 | dextrose | 8.100 |
| 4 | lecithin | 8.000 |
| 5 | sodium CMC | 4.000 |
| 6 | sodium citrate | 1.600 |
| | | 100.000 |

Although the pieces were observed to be not completely covered at 2% WG, they were nonetheless observed to have an elegant film coating.

### Example 2 Comparative

In this example, the process of Example 1 was repeated using slightly different formulas for the subcoat and pearlescent coating. Specifically, in order to show the effect that removing the cellulosic polymer has on the pearlescence of the final product, a gum arabic-based subcoat was applied to brown lentils prior to color coat application with an aqueous pearlescent pigment coating system.

### Subcoat Formula

| Item | Common Name | Wt % |
|---|---|---|
| 1 | purified water | 52.000 |
| 2 | sucrose NF, extra fine grade | 18.000 |
| 3 | gum acacia | 18.000 |
| 4 | tapioca dextrin | 7.000 |
| 5 | parabens solution | 5.000 |
| | | 100.00 |

The lentils were subcoated with the above in a lab conventional pan 30 ml total applied/6 kg charge, and amounting to about a 0.25% theoretical weight gain. The subcoat on the lentils was observed to be uneven with rough areas on the exterior as compared to that observed when using the subcoating of Example 1.

After the subcoat dried, the pearlescent coating corresponding to the following formula was applied:

### Pearlescent Coating Formula

| Item | Common Name | Wt % |
|---|---|---|
| 1 | Na CMC | 37.780 |
| 2 | tapioca dextrin | 27.640 |
| 3 | non-platy pearlescent wine red pigment | 20.000 |
| 4 | dextrose monohydrate, FG | 6.660 |
| 5 | lecithin | 6.600 |
| 6 | sodium citrate-dihydrate | 1.320 |
| | Total | 100.00 |

The run was stopped at 1% weight gain. The final products were deemed to be unacceptable because the pearlescent coating did not adhere well to the unevenly subcoated pieces. Furthermore, the higher amount of cellulosic polymer was determined to negatively affect the mouthfeel of the final product.

### Example 3 Comparative

In this example, lentil substrates were again given a subcoat and a pearlescent coat following the procedure set forth above. Specifically, the subcoat of Example 1 was applied to the substrates as a 10% solids solution until about a 1% weight gain was observed. After the subcoated lentils were allowed to dry, the pearlescent coating of Ex. 2 was applied at a 2% weight gain. Although the final products looked had a shiny, metallic looking finish and had a smooth, uniform pearlescent coating, the taste profile and mouthfeel were again found to be unacceptable due the high content of cellulosic polymer. It has thus been shown that not only is it important to have a substantially smooth surface upon which to apply the pearlescent coating (as shown by the results when gum arabic coating replaced the HPMC coating), but it is also important to select a pearlescent coating which has a relatively low amount of cellulosic polymer in order to achieve a final product which is not only elegant in appearance but also one which has superior mouthfeel.

### Example 4 Comparative

In this example, uncoated yellow chocolate lentils (no-subcoat) were pan coated with the pearlescent coating of Example 1 applied 1% total weight gain. The coating process was stopped because of poor adhesion of the pearlescent coat to the lentil, which was visible early in the run, and non-uniformity of the coating on pieces with an overall rough coating. The coated pieces were also tackier than that obtained in previous runs when a subcoat was used to provide a substantially smooth surface. Thus, it can be seen that even though the pearlescent coatings of the present invention are capable of providing a finish which is visually appealing with a pearlescent appearance and acceptable mouthfeel, it is also necessary to apply the coating to a substantially smooth surface.

### Example 5

The process of Example 1 was repeated using brown chocolate lentils which were pan coated in a 24″ pan insert with 2 spray guns. In this case, the subcoat of Example 1 was applied to about a 0.68% weight gain. The gold platy TiO₂ pearlescent coating was changed to a non-platy red wine pearlescent pigment. The resulting finished products were observed to have a high degree of shine and pearlescence and were very smooth to the touch.

### Example 6

In order to demonstrate the applicability of the invention on foods which are not suitable for pan coating, air-brushing of the suspension onto cookies was done. The air brush application was made to simulate spray applied over the take off belt of cooked cookies coming from an oven. A clear subcoat similar to that described in Example 1, was applied to cooled baked cookies to about a 0.75% weight gain before the pearlescent coating of Example 1 was applied to about 0.2% weight gain.

### Example 7

The coating composition of this example was dispersed in water at 6% solids and sprayed onto pretzels, which were uncoated but substantially smooth substrates to begin with. The coating was applied to a 0.3% weight gain to yield coated pretzels that had a pearlescent gold appearance.

### Pearlescent Formula Coating

| Item | Component | Wt % |
|---|---|---|
| 1 | tapioca dextrin | 36.45 |
| 2 | gold platy TiO₂ | 50.00 |
| 3 | dextrose | 5.05 |
| 4 | lecithin | 5.00 |
| 5 | sodium CMC | 2.50 |
| 6 | sodium citrate | 1.00 |
| | | 100.000 |

While there have been described what are presently believed to be the preferred embodiments of the invention, those skilled in the art will realize that changes and modifications may be made thereto without departing from the spirit of the invention. It is intended to claim all such changes and modifications that fall within the true scope of the invention.

What is claimed:

1. A dry powder mixture useful in preparing film coatings, comprising:
a) from about 5 to about 50% by weight of a pearlescent pigment;
b) from about 15 to about 90% by weight tapioca dextrin;
c) from about 2 to about 10% by weight of a surfactant;
d) less than about 5% by weight of a cellulosic polymer; and
e) from about 0 to about 20% by weight dextrose.

2. The powder mixture of claim 1, wherein said cellulosic polymer is present in an amount of from about 1 to about 4.9% by weight.

3. The powder mixture of claim 2, wherein said cellulosic polymer is present in an amount of from about 2 to about 4% by weight.

4. The powder mixture of claim 1, wherein said cellulosic polymer is selected from the group consisting of hydroxypropylmethyl cellulose and sodium carboxymethylcellulose.

5. The powder mixture of claim 4, wherein said cellulosic polymer is sodium carboxymethylcellulose.

6. The powder mixture of claim 1, wherein said tapioca dextrin is present in an amount of from about 25 to about 60% by weight.

7. The powder mixture of claim 6, wherein said tapioca dextrin is present in an amount of from about 45 to about 60% by weight.

8. The powder mixture of claim 1, wherein said surfactant is present in an amount of from about 5 to about 9% by weight.

9. The powder mixture of claim 8, wherein said surfactant is present in an amount of from about 7.0 to about 8.5% by weight.

10. The powder mixture of claim 1, wherein said surfactant is selected from the group consisting of lecithin, stearic acid, polysorbates, monoglycerides, diglycerides and mixtures thereof.

11. The powder mixture of claim 1, wherein said surfactant is soya lecithin.

12. The powder mixture of claim 1, wherein said dextrose is present in an amount of from about 5 to about 15% by weight.

13. The powder mixture of claim 12, wherein said dextrose is present in an amount of from about 7 to about 10% by weight.

14. The powder mixture of claim 1, wherein said pearlescent pigment is present in an amount of from about 6 to about 20% by weight.

15. The powder mixture of claim 13, wherein said pearlescent pigment is present in an amount of from about 7 to about 13% by weight.

16. The powder mixture of claim 1, wherein said pearlescent pigment comprises titanium dioxide platelets.

17. The powder mixture of claim 1, wherein said pearlescent pigment comprises micaceous pearlescent pigments.

18. The powder mixture of claim 1, further comprising a buffer.

19. The powder mixture of claim 18, wherein said buffer is sodium citrate.

20. The powder mixture of claim 19, wherein said buffer is present in an amount of from to about 0.01 to about 3% by weight.

21. The powder mixture of claim 1, further comprising a member of the group consisting of: colorants, flavorants, glidants and mixtures thereof.

22. The powder mixture of claim 21, wherein said colorants are present in an amount of from to about 0.0001 to about 30% by weight.

23. The powder mixture of claim 21, wherein said colorants are selected from the group consisting of FD&C lakes, titanium dioxide, dyes and natural colorants.

24. A suspension for coating edible substrates comprising:
a) from about 5 to about 30% by weight of the powder mixture of claim 1; and
b) from about from about 70 to about 95% by weight water.

25. The suspension of claim 1, wherein said water is present in an amount of from about 80 to about 95% by weight.

26. A method of coating edible substrates, comprising coating an edible substrate with the suspension of claim 24.

27. The method of claim 26, further comprising applying a subcoat to said edible substrate prior to said coating of said edible substrate.

28. The method of claim 27, wherein said subcoat comprises a cellulosic polymer.

29. The pearlescent coated edible substrate prepared by the method of claim 26.

30. The pearlescent coated edible substrate prepared by the method of claim 27.

31. The pearlescent coated edible substrate prepared by the method of claim 28.
